(19) United States
(12) Patent Application Publication
(10) Pub. No.: US 2021/0011975 A1
(43) Pub. Date: Jan. 14, 2021

(54) SYSTEM AND METHOD FOR THE AUTOMATED TRACKING OF PERSONAL AND EMOTIONAL INFORMATION OF INDIVIDUALS

(71) Applicant: Pegah AARABI, Richmond Hill (CA)

(72) Inventor: Pegah AARABI, Richmond Hill (CA)

(21) Appl. No.: 16/685,819

(22) Filed: Nov. 15, 2019

Related U.S. Application Data
(60) Provisional application No. 62/871,939, filed on Jul. 9, 2019.

(51) Int. Cl. G06F 17/27; G06F 17/28; G09B 7/06

(52) U.S. Cl. CPC G06F 17/2715; G09B 7/06; G06F 17/2809; G06F 17/2854

(57) ABSTRACT

The present disclosure provides a system and method for collecting personal information about an individual. The system and method comprises memory for storing personal information schemas, personal data, emotional data, a communication interface to send a plurality of questions to a user interface and to receive a plurality of responses from the user interface, and a processor: to translate the personal information schemas into a plurality of questions, to translate the responses into personal data or emotional data mapped to the personal information schemas and to analyze the personal information schemas, personal data and emotional data to provide an action.

### CROSS-REFERENCE TO RELATED APPLICATIONS

This application claims the benefit of U.S. 62/871,939, which is incorporated herein in its entirety by reference.

### FIELD OF INVENTION

The present disclosure relates to a system and method for tracking emotional and personal information to aid in the wellness of individuals.

### BACKGROUND

The advent of the information age has propelled many people to collect data on individuals. This data has been used before for targeted ads, or to adjust personal preferences on devices to suit the individual using the device. However, despite all advances, not only is the collection of the data difficult, but it is often done in a very artificial way. Forms or surveys are often used, and in many instances, these can be confusing as to the type of information that is being requested. In addition, the quality of the information collected may be low if the collection methodology is too simplistic or artificial.

### SUMMARY

The present disclosure provides a system and method for collecting personal and emotional information about an individual. More particularly, the present disclosure relates to a system and method of interacting with an individual via natural language to collect personal and emotional data and to provide an action based on the collected personal data. The system and method comprises memory for storing personal information schemas and personal data, a communication interface to send a plurality of questions to a user interface and to receive a plurality of responses from the user interface, and a processor: to translate the personal information schemas into a plurality of questions, to translate the responses into personal data mapped to the personal information schemas and to analyze the personal information schemas and personal data to provide an action.

### BRIEF DESCRIPTION OF THE DRAWINGS

FIG. 1 is a block diagram of a system for the automated intelligence collection of individuals.

FIG. 2 is a flowchart of a method for the automated intelligence collection of individuals.

FIG. 3 is a block diagram of an example of the method depicted in FIG. 2 where personal data is missing from memory.

FIG. 4 is a block diagram of an example of the method depicted in FIG. 2 where missing personal data has been converted into questions, and the questions are being sent to an individual via the communications interface.

FIG. 5 is a block diagram of an example of the method depicted in FIG. 2 where responses to the questions have returned and the responses are being converted back into personal data.

FIG. 6 is a block diagram of an example of the method depicted in FIG. 2 where personal data is being stored in memory within personal information schemas.

FIG. 7 is a block diagram of another example of a system for the automated intelligence collection of individuals.

FIG. 8 is a block diagram of another example of a system for the automated intelligence collection of individuals.

FIG. 9 is a block diagram of another example of a natural language processor depicted in FIG. 1.

FIG. 10 is a table showing an example of the method depicted in FIG. 2 where responses are translated into emotional data.

FIG. 11 is a table showing an example of the method depicted in FIG. 2 where responses are translated into emotional data.

### DETAILED DESCRIPTION

Data that is collected through surveys and forms provides an impersonal experience and can be confusing as to the type of information being requested. In addition, when data is required repeatedly for tracking or when data requires constant updating, it can be quite cumbersome and annoying to the individual filling out the survey and forms.

The present disclosure provides a system and method for the automated intelligence collection of individuals, whereby personal information and emotional data is collected by interacting with an individual through a series of questions and responses via a user interface. The personal data and emotional data is stored and further analyzed to provide an action. By doing this, collection of data is more natural, and can elicit better quality data from the individual. In addition, repetitive requests for data will likely annoy the individual less, and it is much more likely that the individual will respond rather than ignoring the request for data.

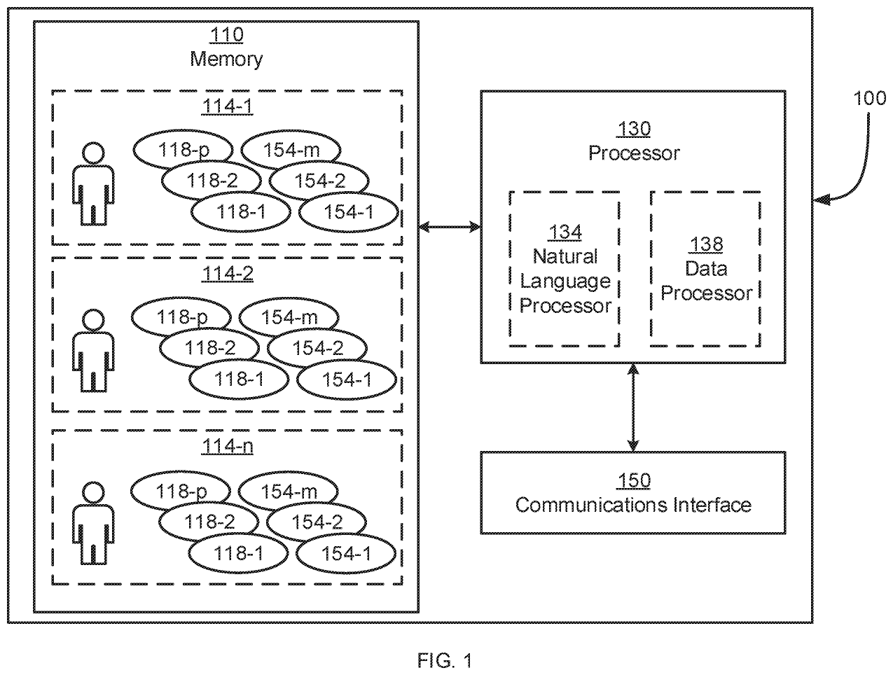

FIG. 1 depicts an example system for the automated intelligence collection of individuals 100. System 100 includes a memory 110 to store a plurality of personal information schemas 114-1, 114-2 . . . 114-n, personal data 118-1, 118-2 . . . 118-p and emotional data 154-1, 154-2 . . . 154-m. (Personal information schemas 114 are referred to herein generically as personal information schema 114 and collectively as personal information schemas 114. This nomenclature is used elsewhere herein.) The memory 110 includes a non-transitory computer-readable medium that may include volatile storage, such as random-access memory (RAM) or similar, and may include non-volatile storage, such as a hard drive, flash memory, and similar.

Stored within memory 110, each personal information schema 114 maintains a blueprint of personal data 118 representing an individual. In the present embodiment, personal information schemas 114 contain classes of different personal data 118 for each individual. Classes (also known as subject fields) of personal data 118 include, without limitation, a date of birth, the family structure of the individual, medical issues of the individual, the location and/or address of the individual, the names of the closest family members of the individual, along with their dates of birth, locations, and their relationship to the individual. Other classes of personal data 118 may also be used.

Each personal information schema 114 also maintains a series of emotional data 154 that is stored over time. In the present embodiment, personal information schemas 114 contains snapshots in time of an individual's emotional state stored as emotional data 154. Over time, additional snapshots are captured and stored as emotional data 154. For example, the first snapshot is stored as emotional data 154-1, the second snapshot is stored as emotional data 154-2, and the m-th number snapshot is stored as emotional data 154-m. Emotional data 154 can include, without limitation, the happiness of an individual, the anger of an individual, and the anxiousness of an individual. Other types of emotional data 154 may also be stored.

In the present embodiment, personal information schemas 114 are homogenous in classes across different individuals. The personal information schemas 114-1, 114-2 and 114-n represent different individuals and contain the same classes. For example, 114-1, 114-2 and 114-n contain personal data 118-1, which represents the name of the individual. In this example, 114-1, 114-2 and 114-n also contain emotional data 154-1. A person skilled in the art will recognize that personal information schemas 114 can be non-homogenous and can contain multiple different classes of information across different individuals.

System 100 further includes processor 130, also referred to herein as a central processing unit (CPU), interconnecting memory 110 and communications interface 150. Memory 110 stores computer-readable data and programming instructions, accessible and executable by processor 130. In the present embodiment, memory 110 stores personal information schemas 114, and personal data 118, both of which can be used by processor 130 to execute operations to interact with an individual via communications interface 150. Various forms of computer-readable programming instructions may be stored in memory 110 to be executed by processor 130.

In the present embodiment, processor 130 further includes natural language processor 134 and data processor 138. Natural language processor 134 translates personal information schema 114 into natural language questions for interaction with individuals, and translates natural language responses into personal data 118 based on the mapping of personal information schema 114. Data processor 138 determines whether interaction is necessary based on analyzing the personal data 118 available in memory 110. Natural language processor 134 and data processor 138 will be further discussed in greater detail below.

System further includes communications interface 150. Communications interface 150 allows system 100 to connect to other devices. Communications interface 150 can also connect processor 130 to input and output devices (not shown) via another computing device. Examples of input devices include, but are not limited to, a keyboard and a mouse. Examples of output devices include, but is not limited to, a display showing a user interface. Alternatively, or in addition, the input and output devices can be connected to processor 130. In other words, input and output devices can be local to system 100 by connecting to processor 130, or remote by connecting via another computing device via communications interface 150. Different input and output devices and a variety of methods of connecting to processor 130, either locally or via communications interface 150, may be used.

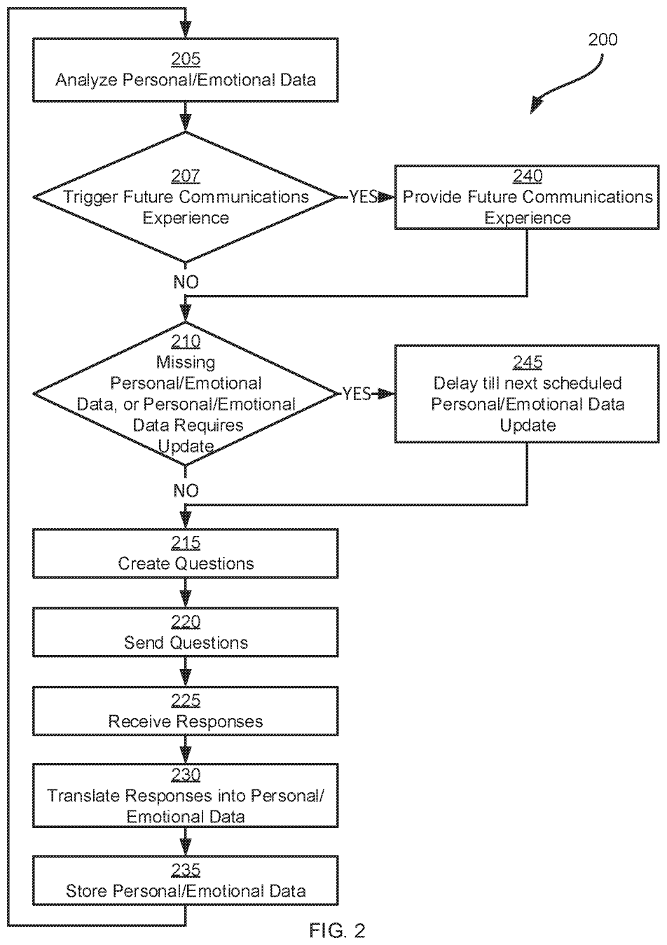

Referring now to FIG. 2, a method for automated intelligence collection is represented in the form of a flowchart which is generally indicated at 200. Method 200 can be performed using system 100, although it is understood that method 200 can be performed on variations of system 100, and likewise it is to be understood that method 200 can be varied to accommodate variations of system 100.

At block 205, data processor 138 analyzes personal information schema 114. In the current embodiment, on initial use of system 100, there is no personal data 118, nor is there emotional data 154 in personal information schema 114, stored in memory 110. As such, in the current embodiment, at block 207, system 100 determines not to trigger an action (also referred herein as a future communications experience) due to the lack of personal data 118 and emotional data 154. Block 207 will be further discussed in greater detail below.

As depicted in block 210, the analysis determines what personal data 118 is available, whether there is any missing personal data 118, or whether personal data 118 requires updating. Determination of whether personal data 118 requires updating can be dependent on the class as indicated in personal information schema 114. For example, an individual's date of birth only needs to be updated once, whereas the current medical information of an individual will need to be updated at regular intervals. Another example of whether personal data 118 requires updating can be dependent on whether a class of personal data 118 in personal information schema 114 has been updated multiple times within a short time span, indicating that a new update is unnecessary. Further, updating may be used to improve data accuracy, as an individual may have ignored a previous question or given an inaccurate response to a previous question. The data being captured relates to emotional state and, given that the respondents are human beings, it may be the case that an individual does not answer or answers in an inaccurate manner. As such, updating may be performed to gradually increase data quality.

Determination of whether emotional data 154 requires updating can be dependent on the frequency of snapshots, or updating emotional data 154 can be based on a predetermined schedule. For example, if emotional data 154 was recently obtained, then it may not be necessary to obtain additional emotional data 154. Another example of whether emotional data 154 requires updating is if emotional data 154 was previously scheduled to be obtained at regular intervals, such as daily, weekly or monthly. If an update of personal data 118 or emotional data 154 is not required, then system 100 is delayed until the next interval when either personal data 118 or emotional data 154 is required, as depicted at block 245. Various methods may be used to determine whether personal data 118 or emotional data 154 requires updating.

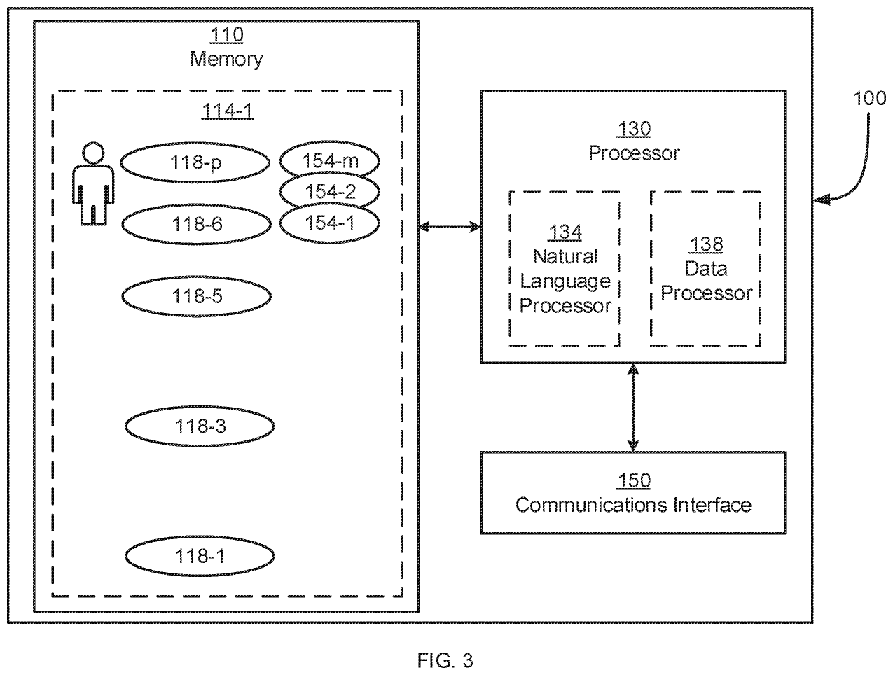

FIG. 3 depicts an example scenario at block 210 where data processor 138 analyzes the personal information schema 114, and determines there is missing personal data 118, more specifically, personal data 118-2 and 118-4 is missing. A person skilled in the art will recognize that this example scenario is interchangeable between whether personal data 118 is analyzed and deemed required by system 100 or if the next snapshot of an individual's emotional state needs to be captured as emotional data 154.

Referring again to FIG. 2, at block 215, natural language processor 134 creates questions based on the missing personal data 118. Natural language processor 134 determines the missing data from the personal information schema 114, and then creates a natural language question that is easily understood by an individual.

For example, personal information schema 114 indicates that missing personal data 118-2 is the date of birth of the individual as depicted in FIG. 3. Natural language processor 134 may compose the question “What is your birthday?” to send to the individual. Alternatively, natural language processor 134 may compose the question “When were you born?” to send to the individual.

In an alternate example, personal schema indicates that the next emotional data 154 snapshot is required. Natural language processor 134 may compose the question “How do you feel today?” to send to the individual.

In the current embodiment, natural language processor 134 selects the question based on a pre-existing database of questions randomly, or alternatively, based on the frequency of previous use of the questions within the same class in personal information schema 114. As an example, if the question “How do you feel today? has been asked before, then natural language processor 134 may select the question “Are you doing ok?” In an alternative embodiment, natural language processor 134 uses an artificial intelligence to determine the natural language question to send to the individual. Different variations and methods of implementing a natural language processor 134 may be used to compose a question based on the class indicated by personal information schema 114.

Further, different phrasings of questions may elicit different responses. Questions of overlapping or coincident scope may be used to improve data quality, as an individual may respond differently to different phrasings of the same general question.

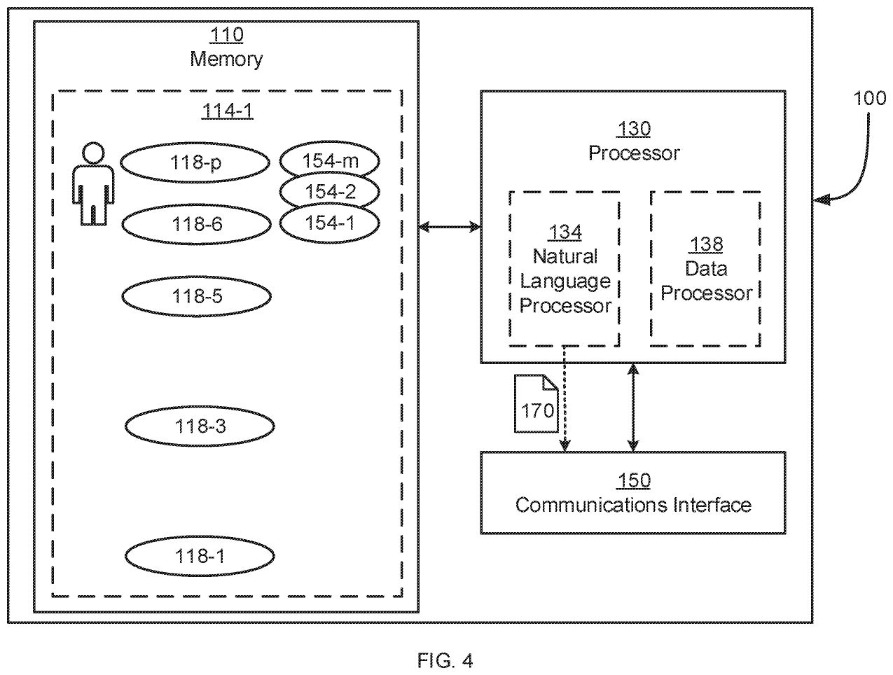

At block 220, once questions have been created, they are compiled into a question package 170 and sent to a display with a user interface (not shown) either via processor 130 if the display is connected locally, or via communications interface 150 if the display is commented remotely. This is depicted in FIG. 4. Question package 170 is comprised of a class (also known as subject field) for each question. For example, a question asking “What is your birthday” will be of the “Birthday” class. Questions within question package 170 can be ordered and displayed based on randomness or based on a ranking of a pre-determined importance. If sent through communications interface 150, question package 170 can be sent as multiple mediums. As an example, question package 170 can be sent using electronic mail via communications interface 150. A person skilled in the art will recognize the different communication mediums that question package 170 can be sent to an individual.

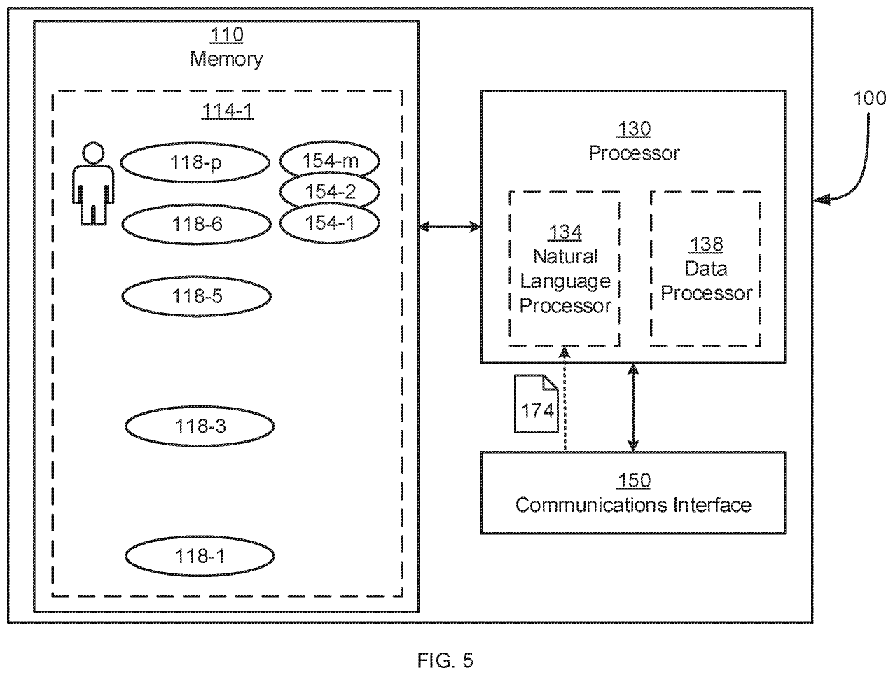

At block 225, response package 174 is received by natural language processor 134 based on question package 170 from communications interface 150. Response package 174 is comprised of a class for each question, the corresponding question, and the response for each question. At block 230, natural language processor 134 translates the responses into personal data 118 or emotional data 154. In the current embodiment, as depicted in FIG. 5, response package 174 is translated by natural language processor 134 into personal data 118-2 and 118-4.

Depending on the question, and the expected response, natural language processor 134 can convert the response into personal data 118 or emotional data 154. One way of doing this is using sentiment analysis. For example, if a birth date is expected, then natural language processor 134 will look for a date. In an alternative example, if emotional data 154 is expected, then the response can be parsed looking for keywords, such as “good” or “depressed, or phrases such as “I'm not too bad”. Keywords or phrases can be given scores and added or multiplied together if there are multiple occurrences. The score would be an example of emotional data 154.

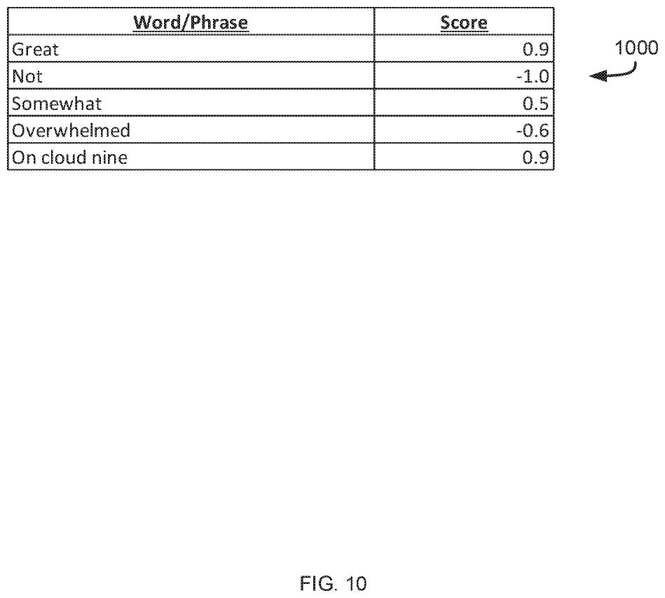

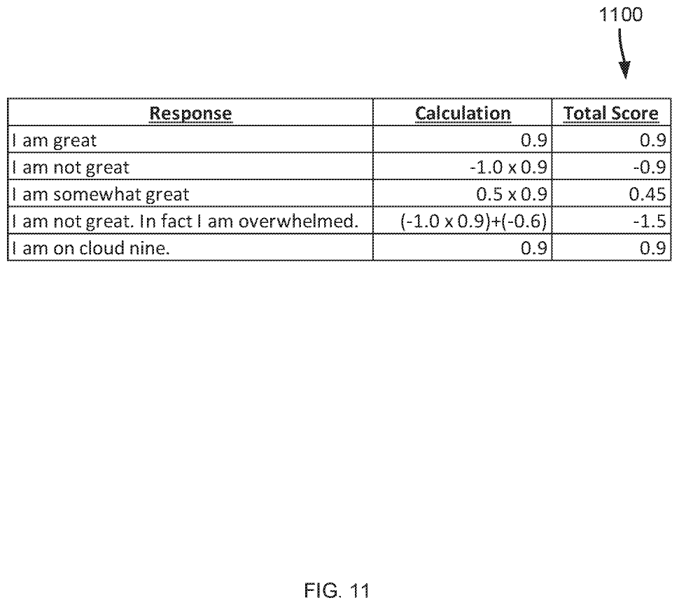

Referring to FIG. 10 as an example rule of the calculation to obtain a score for emotional data 154, the words “great”, “not”, and “somewhat” are given scores of 0.9, −1.0 and 0.5 respectively as can be seen in table 1000. The negative score indicates a negative feeling, and the positive score indicates a positive feeling. All scores and the associated words are stored in memory 110. As can be seen in table 1100 in FIG. 11, when natural language processor 134 receives a response of “I am great”, it parses the response and detects the word “great” and assigns the response a score of 0.9 to be stored as emotional data 154. If natural language processor 134 receives a response of “I am not great”, it parses the response and detects the words “not” and “great” and multiples the associated scores of each word to get a total score of −0.9 to be stored as emotional data 154. Likewise, if natural language processor 134 receives a response of “I am somewhat great”, it parses the response and detects the words “somewhat” and “great” and multiplies the associated scores of each word to get a total score of 0.45 to be stored as emotional data 154.

In another embodiment, an individual may provide a response with multiple sentiments. In the event that multiple sentiments are detected, scores can be summed together. Referring to table 1100 again, a response of “I am not great. In fact I am overwhelmed” would contain two sentiments, the first of being “not great” and the second of being “overwhelmed.” In this example, the first sentiment would continue to use the multiplication as indicated in previous examples, and the second sentiment could be summed to with the first sentiment, giving a final score of −1.5.

Scores can also be provided to phrases. As an example, “on cloud nine” is a phrase that indicates a positive feeling and is assigned a score of 0.9. Similar to words, if a phrase is detected, then the corresponding score will be used.

In other embodiments, scores could be multi-dimensional rather than single dimensioned such as in the previous example. An example of a multi-dimensional score could be a score to indicate the happiness of the individual, another score to indicate the anxiousness of an individual, and another score to indicate the anger level of an individual. Natural language processor 134 could process a response and determine the scores for each emotion through multiplying scores for each dimension, and store them as emotional data 154. Multi-dimensional scores would allow for a more accurate depiction of an individual's emotion.

In another embodiment, conversion to emotional data 154 can be performed using a bi-gram or a tri-gram for natural language processor 134, where the probabilities of two or three sequential words provides a relation to different emotional scores.

A person skilled in the art will now recognize the different methods that natural language processor 134 can use to convert responses into personal data 118 or emotional data 154.

Returning to FIG. 5, in the event that response package 174 cannot be translated into personal data 118, natural language processor 134 will return an error message through communications interface 150 to the user interface and request another response from the individual. An example of this is message such as “I didn't get it, can you please tell me more clearly?” In the event that natural language processor 134 fails to translate a repeated request for a response for the same class of personal information schema 114 into personal data 118, natural language processor 134 can compose a different question to obtain the same objective response from the individual.

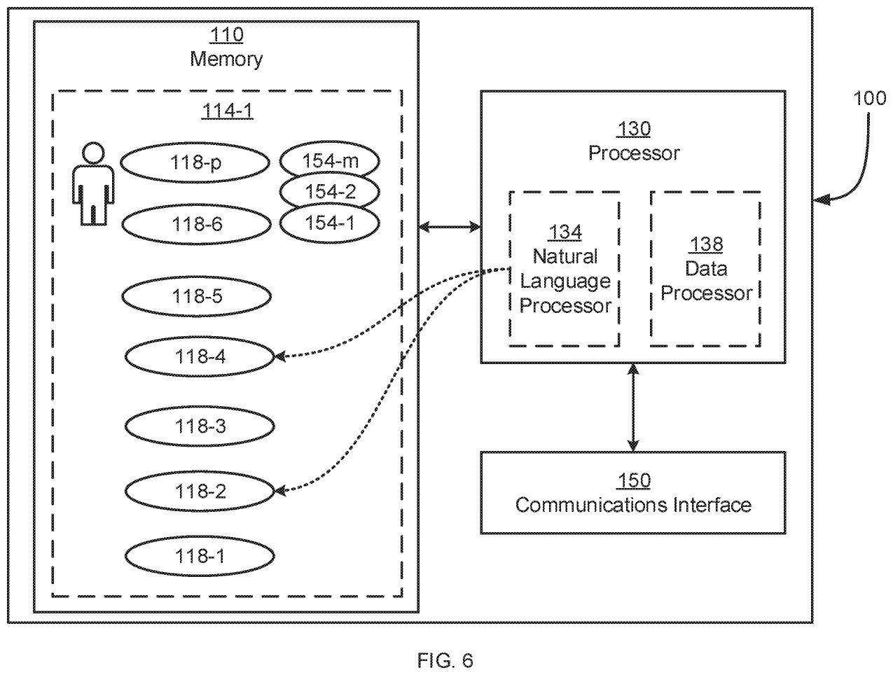

Once response package 174 has been translated into personal data 118 or emotional data 154, personal data 118 or emotional data 154 will be mapped to personal information schema 114 and stored in memory 110 as shown in block 235. In the current embodiment, this is depicted in FIG. 6., where response package 174 has been translated into personal data 118-2 and 118-4, and then stored in memory 110.

In the current embodiment, the corresponding personal information schema 114, the class, the question, the response, the date of the response, and personal data 118 or emotional data 154 will be stored in memory 110 to be tracked over time. However, other information relevant to the class, responses and questions could be stored as well.

Once personal data 118 has been stored in memory 110, the process loops and starts again at block 205. After the analysis at block 205, system 100 determines whether to trigger future communications experience at block 207. Determining whether to trigger future communications experience can be based on whether conditions are met. As an example, a preconfigured condition may be if there are three consecutive snapshots of emotional data 154 showing depression. If the analysis of emotional data 154 at block 205 determines that the preconfigured condition has been met, then system 100 will provide a future communications experience at block 240.

Another example of preconfigured conditions is a calculation of the average emotional scores after a predefined period, and before a predefined period taken from tracked emotional data 154. The difference between the average emotional scores would be an indicator of the emotional state of an individual during that predefined period. If the difference is lower than the preconfigured condition, then a future communications experience could be triggered. For example, if the average emotional score after the predefined period up to today is 10, and the average emotional score from the beginning of available emotional data 154 is 15, then the average difference in emotional score during the predefined period is −5. This could meet the preconfigured conditions.

If no preconfigured conditions are met, then system 100 determines whether further questions are required at block 210. There are many variations on preconfigured conditions, which could include, but is not limited to a simple one score emotional data 154 condition, such as a score with a negative number, or a complicated calculation of tracked emotional data 154 over time.

Future communications experience includes sending communications to the individual regarding relevant information pertaining to the personal information schema 114, personal data 118 and emotional data 154. For example, a possible future communications experience is to send a “Happy Birthday” message to the individual from data processor 138 via communications interface 150 on the annual birthday of the individual. Furthermore, assuming personal information schema 114 contains classes regarding relatives of the individual, the “Happy Birthday” message can be made to seem it was coming from one of the relatives.

In alternative examples, future communications experience can involve a third party. For example, videos can be prerecorded by third parties to be released to the individual when preconfigured conditions are met. More specifically, a motivational message from a deceased family member can be released when the individual has several snapshots of emotional data 154 showing the individual as depressed. Another example of a future communications experience involving a third party would be for a third party to be alerted when preconfigured conditions are met, such as alerting a third party that the individual is lonely if emotional data 154 showed multiple consecutive negative scores indicating loneliness. A person of skill in the art will now appreciate the variety of future communications experiences that can be generated.

While the foregoing describes certain embodiments, a person of skill in the art will now recognize that variations, combinations and subsets thereof are contemplated. For example, collection of personal data 118 or emotional data 154 to be placed within personal information schema 114 can be collected via external databases or social media accounts through an interface link. Personal data 118 or emotional data 154 can be scraped from external sources, and then stored in memory 110 via processor 130 and communications interface 150. A person of skill in the art will now appreciate the variety of sources form which personal data 118 or emotional data 154 can be collected.

In another embodiment, personal information schema 114 may also be expanded to include the question composed by natural language processor 134. For example, in the class defined as “date of birth”, the personal information schema 114 may include “When is your birthday” as part of the class, along with personal data 118. Other embodiments may also include the response from the individual prior to natural language processor 134 translating the response into personal data 118. A person of skill in the art will now recognize the different variations and fields available in personal information schema 114.

Applications of the present disclosure may extend beyond providing future communications experience. For example, personal information schema 114 may be expansive and contain enough personal data 118 to provide a basis to simulate an individual and provide bidirectional communications between a simulated individual and the individual using system 100.

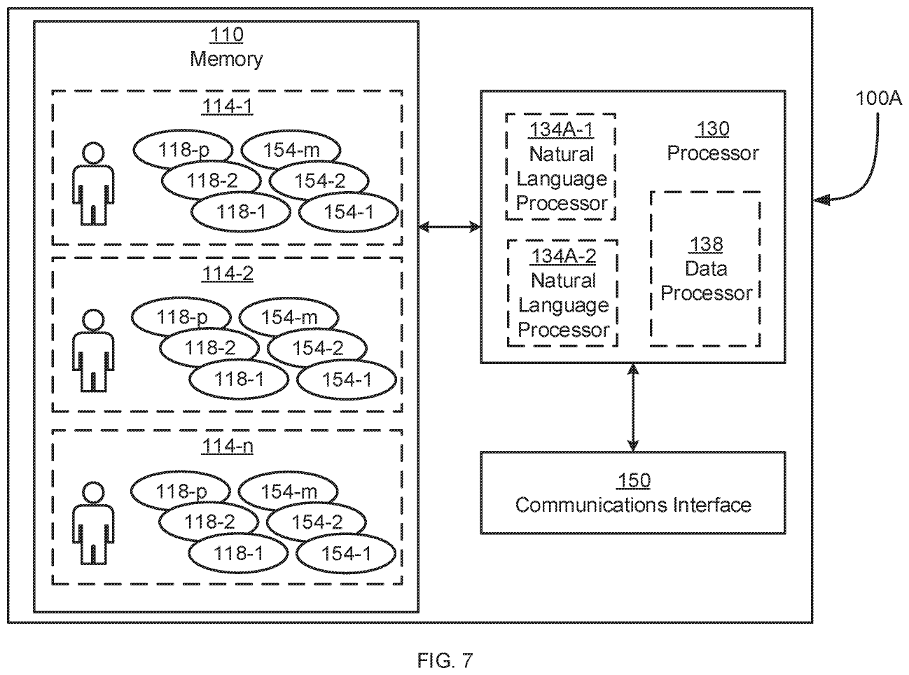

According to another embodiment, FIG. 7 depicts another system for the automated intelligence collection of individuals indicated generally at 100A. System 100A is a variant on system 100 and thus like elements in system 100A bear like references to counterpart elements in system 100. Of note is that in system 100A, there is a first natural language processor 134A-1 to translate the personal information schemas 114 into a plurality of questions, and there is a second natural language processor 134A-2 to translate the plurality of response received from the individual into personal data 118 and emotional data 154.

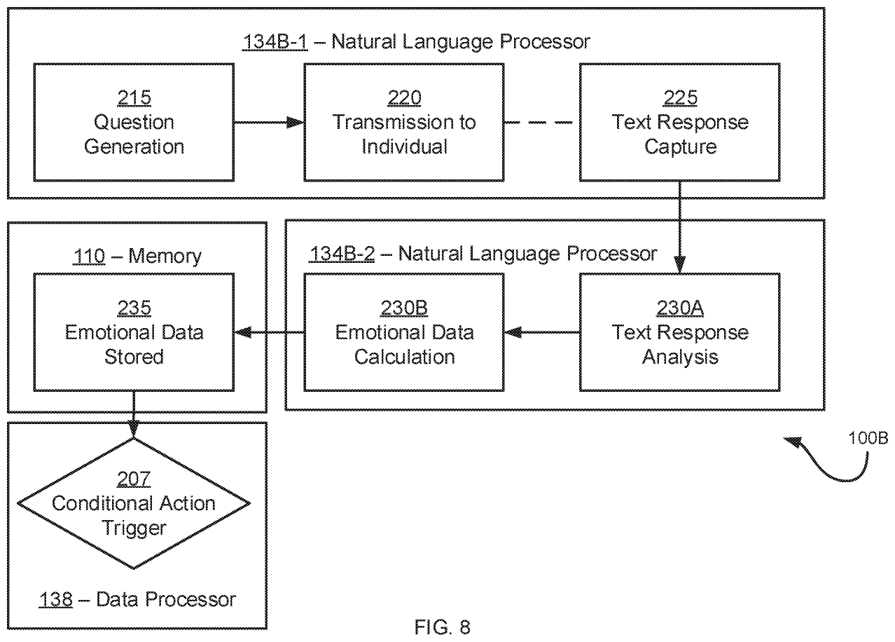

According to another embodiment, FIG. 8 is a block diagram that depicts another system for the automated intelligence collection of individuals indicated generally at 100B. System 100B is a variant on system 100 and thus like elements in system 100B bear like references to counterpart elements in system 100. Of note is that in system 100B, several steps of method 200 may occur as part of the operation of parts of system 100B. For example, question generation at block 215, transmission to individual at block 220 and text response capture at block 225 all occur as part of the first natural language processor 134B-1. In this example, Block 230 in FIG. 2 is broken down into blocks 230A and 230B, where the text response is analyzed at block 230A, and then emotional data 154 is calculated at block 230B. Once calculated, emotional data 154 is stored in memory 110. Conditional action trigger at block 207 determines whether to perform future communications experience. In this fashion it will now be apparent that system 100 can be implemented in other ways, in addition to system 100A and 100B.

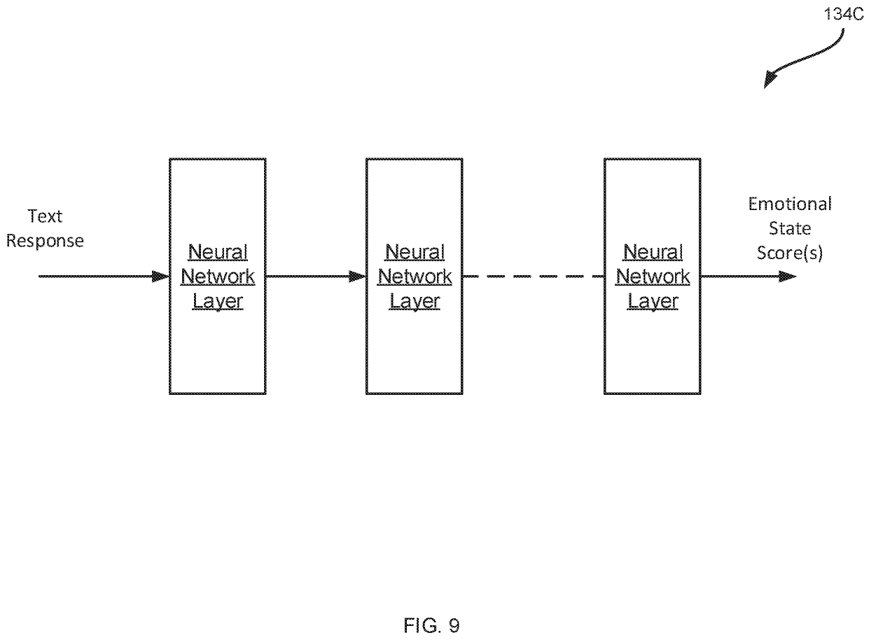

In an alternate embodiment, as depicted in FIG. 9, natural language processor 134C can be a deep neural network, consisting of a neural network that takes as its input a series of words that comprise the response from the individual, and outputs emotional data 154. An example of this is a deep convolutional neural network, where each of many layers of neurons are convolutionally interconnected. This neural network would be trained based on the words and phrases from responses, and could be implemented via techniques such as back propagation. As shown in FIG. 9, a deep neural network takes in as input the text response of the individual and through a series of neural lawyers infers the emotional data 154 associated with the response. Variations of natural language processor 134 will now be apparent.

1. A system for collecting personal information and emotional data about an individual, the system comprising:
a memory to store a plurality of personal information schemas, personal data and emotional data;
a communication interface to send a plurality of questions to a user interface and receive a plurality of responses from the user interface; and
a processor to:
translate the personal information schemas into the plurality of questions;
translate the plurality of responses from the user interface into the personal data or the emotional data mapped to the personal information schemas; and
analyze the personal information schemas, the personal data and emotional data to provide an action.

2. The system of claim 1, wherein the processor comprises a first natural language processor to translate the personal information schemas into a plurality of questions; a second natural language processor to translate the plurality of responses from the user interface into the personal data and the emotional data mapped to the personal information schemas; and a data processor to analyze the personal information schemas, the personal data and the emotional data to provide an action.

3. The system of claim 1, wherein the personal information schema comprises a plurality of classes, a corresponding question and, the personal data or the emotional data.

4. The system of claim 1, the communication interface further comprising an interface link to an external database for receipt of the personal data or the emotional data.

5. The system of claim 1, the action comprising a future communications experience with a third party.

6. A method for collecting personal information about an individual, the method comprising:
creating a plurality of questions using a processor based from a personal information schema, a plurality of available personal data and a plurality of emotional data;
sending the plurality of questions to a user interface through a communication interface;
receiving a plurality of responses to the plurality of questions from the user interface through the communication interface;
translating the plurality of responses using the processor into the personal data or emotional data;
storing the personal data, the emotional data and a corresponding personal information schema into a memory; and
analyzing the personal information schema, the personal data and the emotional data using the processor to provide an action.

7. The method of claim 6, wherein creating the plurality of questions is performed by a first natural language processor, translating the plurality of responses is performed by a second natural language processor, and analyzing the personal information schema, the personal data and the emotional data to provide an action performed by a data processor.

8. The method of claim 6, further comprising receiving the personal data or the emotional data from an external database through an interface link in the communication interface.

9. The method of claim 6, wherein providing the action comprises a future communications experience with a third party.

10. A non-transitory computer-readable medium comprising instructions executable by a processor to:
create a plurality of questions using the processor based from a personal information schema, a plurality of available personal data and a plurality of emotional data;
send a plurality of questions to a user interface through a communication interface;
receive a plurality of responses to the plurality of questions from the user interface through the communication interface;
translate the plurality of responses using the processor into the personal data or the emotional data;
store the personal data, the emotional data and a corresponding personal information schema into a memory; and
analyze the personal information schema, the personal data and the emotional data using the processor to provide an action.

11. The non-transitory computer-readable medium of claim 10, wherein the instructions are to create the plurality of questions and translate the plurality of responses using a natural language processor.

12. The non-transitory computer-readable medium of claim 10, wherein the instructions are to receive the personal data or the emotional data from an external database through an interface link in the communication interface.

13. The non-transitory computer-readable medium of claim 10, wherein the action comprises a future communications experience with a third party.
